(19) United States
(12) Patent Application Publication
(10) Pub. No.: US 2007/0173624 A1
(43) Pub. Date: Jul. 26, 2007

(54) SINGLE-COMPONENT POLYORGANOSILOXANE COMPOSITIONS CROSSLINKABLE INTO SILICONE ELASTOMERS

(76) Inventors: Marc Chaussade, Villeurbanne (FR); Christiane Prebet, Taluyers (FR)

Correspondence Address: BUCHANAN, INGERSOLL & ROONEY PC, POST OFFICE BOX 1404, ALEXANDRIA, VA, 22313-1404, US

(21) Appl. No.: 10/562,048

(22) PCT Filed: Jun. 9, 2004
(86) PCT No.: PCT/FR04/01423

§ 371 Date: Feb. 22, 2007

(30) Foreign Application Priority Data
Jun. 27, 2003 (FR) 03/07815

(51) Int. Cl. C08G 77/08; C08L 83/04

(52) U.S. Cl. 528/14; 524/588

(57) ABSTRACT

Single-component polyorganosiloxane (POS) compositions which are stable on storage in the absence of moisture and which crosslink, in the presence of water, into an elastomer, contain at least one crosslinkable linear polyorganopolysiloxane POS, an inorganic filler and a crosslinking catalyst, wherein the POS exhibits non-hydroxylated functionalized endgroups, in particular alkoxy, oxime, acyl and/or enoxy endgroups, preferably alkoxy endgroups, said compositions being essentially devoid of POS possessing hydroxylated endgroups and said catalyst being a vanadium compound.

The field of the invention is that of single-component silicone mastics which are stable on storage in the absence of moisture and which crosslink by polycondensation, at ambient temperature (for example, 5 to 35° C.) and in the presence of water (for example, ambient moisture), to give elastomers which adhere to various supports.

The formulations of the elastomers which crosslink by polycondensation generally involve a silicone oil, generally polydimethylsiloxane (PDMS), comprising hydroxylated endings which are optionally prefunctionalized by a silane so as to exhibit Si(OR)ₐ ends, a crosslinking agent R_{b}Si(OR′)_{4-b}, where b<3, a polycondensation catalyst, conventionally a tin salt or an alkyl titanate, a reinforcing filler and other optional additives, such as bulking fillers, adhesion promoters, colorants, biocidal agents, and the like. During the crosslinking, atmospheric moisture (or optionally moisture introduced in a portion of the composition, in the case of two-component compositions) makes possible the polycondensation reaction, which results in the formation of the elastomeric network.

These elastomers can be used, as single- or as two-component compositions, in a wide field of application, such as adhesive bonding, rendering leaktight and molding. Single-component products or mastics which crosslink with the help of atmospheric moisture have the greatest outlets.

Such mastics based on silicone elastomers are used in particular in the construction industry, as means for rendering leaktight, for pointing and/or for assembling, inter alia. The Theological qualities of these single-component silicone mastics (pasty form) are the subject of much attention in these applications. It is the same as regards their resistance to bad weather and to heat, their flexibility at low temperature, their ease of use and their rapid crosslinking/curing in situ, on contact with atmospheric moisture.

During its setting, the mastic first forms a surface skin (surface setting) and then the crosslinking has to be continued at the core until curing is complete (core setting). The setting kinetics are an essential criterion of mastics. It is thus of great advantage to be able to have available core-crosslinkable single-component compositions having setting kinetics which are as fast as possible.

U.S. Pat. No. 4,357,443 discloses a single-component composition which can crosslink at ambient temperature comprising a polydiorganosiloxane possessing silanol ends, an alkoxysilane and a vanadium compound. This document mentions the use of the vanadium compound as crosslinking catalyst and the alkoxysilane as crosslinking agent. However, the vanadium compounds exhibit a high reactivity with regard to the silanol ends of the polydiorganosiloxane and it is therefore more than probable that the vanadium compound will graft to the ends of the polydiorganosiloxane and act as crosslinking agent. In addition, it appears that the ability to core crosslink is not retained after aging of the composition, when the latter does not comprise the alkoxysilane (methyltrimethoxysilane). This document does not demonstrate that the vanadium compound can develop a catalyst activity per se in compositions which can be crosslinked to give an elastomer.

EP-A-0 164 470 discloses silicone compositions which can be crosslinked to give a thin layer for releasability. These compositions involve specific silicone oils and varied organometallic catalysts belonging to the following families: titanium esters, zirconium esters, hafnium esters or vanadium oxide esters. The teaching of this document is limited to the ability of these catalysts to induce the crosslinking of specific compositions to give a thin layer, without it being possible for any teaching to be drawn on the ability of these catalysts to be able to result in core crosslinking in the context of mastic compositions.

An object of the present invention is to provide a single-component silicone mastic composition which is stable on storage in the absence of moisture and which is capable of rapidly crosslinking/curing to give an adherent elastomer at ambient temperature (5-35° C.) and in the presence of water contributed essentially by ambient moisture. In particular, an object is to provide such a composition displaying outstandingly fast surface setting kinetics, followed by complete core setting.

Another object of the invention is to provide such a composition which does not give off a toxic volatile product during crosslinking.

These objects, and others, are achieved by the use of a vanadium compound as catalyst or accelerator of the crosslinking reaction of a single-component polyorganosiloxane (POS) composition which is stable on storage in the absence of moisture and which crosslinks in the presence of water to give an elastomer, in which composition the POSs are nonhydroxylated crosslinkable linear POSs exhibiting functionalized ends of alkoxy, oxime, acyl and/or enoxy type, preferably alkoxy type. The invention does not rule out the presence of a minor proportion of POS comprising OH groups, i.e. which can represent less than 10 μmol of OH per g of composition. This is because these POSs can result from a functionalization reaction of a POS possessing hydroxylated endings with a suitable crosslinking agent and in the presence of a functionalization catalyst, and a few POS chains with hydroxylated endings may still remain. Preferably, the POSs according to the invention are entirely devoid of them. The composition can additionally comprise the other conventional ingredients, in particular a filler.

A subject matter of the invention is thus a single-component polyorganosiloxane (POS) composition which is stable on storage in the absence of moisture and which crosslinks in the presence of water to give an elastomer, which composition comprises at least one crosslinkable linear polyorganopolysiloxane POS, an inorganic filler and a crosslinking catalyst, characterized in that the POS exhibits nonhydroxylated functionalized ends, in particular ends of alkoxy, oxime, acyl and/or enoxy type, preferably alkoxy type, in that the composition is essentially devoid of hydroxylated POSs, i.e. less than 10 μmol of OH per g of composition, and in that the catalyst is a vanadium compound.

In a preferred embodiment, said composition is characterized in that it comprises:
-A- at least one crosslinkable linear polyorganopolysiloxane A of formula: 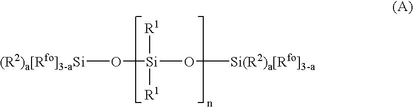
   in which:
   the substituents R¹, which are identical or different, each represent a saturated or unsaturated, substituted or unsubstituted, aliphatic, cyclanic or aromatic, C₁ to C₁₃ monovalent hydrocarbon radical; .
   the substituents R², which are identical or different, each represent a saturated or unsaturated, substituted or unsubstituted, aliphatic, cyclanic or aromatic, C₁ to C₁₃ monovalent hydrocarbon radical;
   the functionalization substituents R^{fo}, which are identical or different, each represent:
      an oxime residue of formula:
         (R³)₂C═N—O—
      with R³ independently representing a linear or branched C₁ to C₈ alkyl, a C₃ to C₈ cycloalkyl or a C₂-C₈ alkenyl,
      an alkoxy residue of formula:
         R⁴O(CH₂CH₂O)_{b}—
      with R⁴ independently representing a linear or branched C₁ to C₈ alkyl or a C₃ to C₈ cycloalkyl and b=0 or 1;
      an acyl residue of formula: 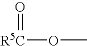
      with R⁵ representing a saturated or unsaturated, branched or unbranched, substituted or unsubstituted, aliphatic, cyclanic or aromatic, C₁ to C₁₃ monovalent hydrocarbon radical,
      an enoxy residue of formula:
         R⁶R⁶C═CR⁶—O—
      with the R⁶ groups, which are identical or different, representing hydrogen or a saturated or unsaturated, branched or unbranched, substituted or unsubstituted, aliphatic, cyclanic or aromatic, C₁ to C₁₃ monovalent hydrocarbon radical,
   n has a value sufficient to confer, on the POS A, a dynamic viscosity at 25° C. ranging from 1000 to 1000000 mPa·s;
   a is zero or 1;
-B- optionally at least one polyorganosiloxane resin B functionalized by at least one radical R^{fo} corresponding to the definition given above and exhibiting, in its structure, at least two different siloxyl units chosen from those of formulae (R¹)₃SiO_{1/2} (M unit), (R¹)₂SiO_{2/2} (D unit), R¹SiO_{3/2} (T unit) and SiO₂ (Q unit), at least one of these units being a T or Q unit, the radicals R¹, which are identical or different, having the meanings given above with respect to the formula (A) and said resin having a content by weight of functional radicals R^{fo} ranging from 0.1 to 10%, it being understood that a portion of the radicals R¹ are radicals R^{fo};
-C- optionally at least one crosslinking agent C of formula:
   (R²)ₐSi[R^{fo}]₄₋ₐ
with R², R^{fo} and a being as defined above,
-D- optionally at least one linear polydiorganosiloxane D which is unreactive and which is not functionalized with R^{fo}, of formula: 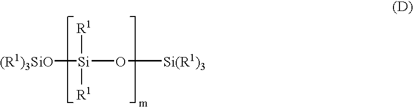
   in which:
   the substituents R¹, which are identical or different, have the same meanings as those given above for the polyorganosiloxane A of formula (A);
   m has a value sufficient to confer, on the polymer of formula (D), a dynamic viscosity at 25° C. ranging from 10 to 200000 mPa·s;
-E- an effective amount of a vanadium compound E as crosslinking catalyst or accelerator;
-F- an inorganic filler F, in particular a reinforcing and/or bulking filler, preferably based on silica;
-H- optionally at least one auxiliary agent H.

The vanadium compounds E can be compounds of vanadium in the 3 (V³), 4 (V⁴) or 5 (V⁵) oxidation states.

In a first embodiment, the compound E is a V⁵ compound and in particular a compound of formula (E₁): X₃VO, in which the radicals X, which are identical or different, are chosen from: 1-electron radical ligands X, in particular alkoxy or halogen atom, and 3-electron radical ligands LX, in particular a ligand derived from acetylacetone, from a β-keto ester, from a malonic ester, from an allyl compound, from a carbamate, from a dithiocarbamate or from a carboxylic acid.

The definition of the ligands is drawn from the work “Chimie Organométallique” [Organometallic Chemistry] by Didier Astruc, published in 2000 by EDP Sciences, cf. in particular Chapter 1, “Les complexes monométalliques” [Monometallic Complexes], pages 31 et seq.

The term “alkoxy group” is understood to mean more particularly an OR group in which R is a linear or branched C₁-C₁₃, in particular C₁-C₈, preferably C₁-C₄, alkyl or a C₃-C₈ cycloalkyl. Mention may be made, as V⁵ compounds corresponding to this definition, by way of example, of trialkoxy vanadates, preferably the following: [(CH₃)₂CHO]₃VO, (CH₃CH₂O)₃VO, [(CH₃)₃CO]₃VO, [(CH₃CH₂)(CH₃)CHO]₃VO or [(CH₃)₂(CH₂)CHO]₃VO.

Mention may be made, as halogen atom, of Cl, Br and F, and Cl is preferred.

Mention may in particular be made, as derivative of acetylacetone or of an allyl compound, of the acetylacetonato (CH₃COCHCOCH₃) and allyl (CH₂═CH—CH₂) radicals.

In another embodiment, the compound E is a V⁴ compound and in particular a compound of formula (E₂): X₂VO, in which the radicals X, which are identical or different, are chosen from: 1-electron radical ligands X, in particular alkoxy or halogen atom, as described above, and 3-electron radical ligands LX, in particular a ligand derived from acetylacetone, from a β-keto ester, from a malonic ester, from an allyl compound, from a carbamate, from a dithiocarbamate or from a carboxylic acid.

Mention may be made, as example of such a compound (E₂), of VOHa₂ (Ha=halogen, e.g. Br, F or Cl), in particular VOCl₂, [(CH₃)₂CHO]₂VO, (CH₃CH₂O)₂VO, [(CH₃)₃CO]₂VO, [(CH₃CH₂)(CH₃)CHO]₂VO or [(CH₃)₂(CH₂)CHO]₂VO.

Mention may in particular be made, as derivative of acetylacetone or of an allyl compound, of the acetylacetonato (CH₃COCHCOCH₃) and allyl (CH₂═CH—CH₂) radicals.

In another embodiment, the compound E is a V⁴ compound of formula (E₃): VX₄, in which the X groups, which are identical or different, are chosen from halogens, in particular Br, F or Cl, and alkoxy groups OR with R representing in particular a linear or branched C₁-C₁₃, in particular C₁-C₈, preferably C₁-C₄, alkyl or a C₃-C₈ cycloalkyl.

Mention may be made, as example of such a vanadium compound (E₃), of the following compounds: [(CH₃)₂CHO]₄V, (CH₃O)₄V, (CH₃CH₂O)₄V, [(CH₃)₃CO]₄V, [(CH₃CH₂)(CH₃)CHO]₄V or [(CH₃)₂(CH₂)CHO]₄V.

In yet another embodiment, the compound E is a V³ compound and in particular a compound of formula (E₄): XVO, in which the radical X is a 3-electron radical ligand LX, in particular a ligand derived from acetylacetone, from a β-keto ester, from a malonic ester, from an allyl compound, from a carbamate, from a dithiocarbamate or from a carboxylic acid. Mention may in particular be made, as derivative of acetylacetone or of an allyl compound, of the acetylacetonato (CH₃COCHCOCH₃) and allyl (CH₂═CH—CH₂) ligands.

In yet another embodiment, the compound E (E₅) is a V⁵ compound with 5-electron radical ligands L₂X, in particular dienyl ligands, especially cyclopentadienyl ligands, e.g. (C₅H₅)₂V or (C₅H₅)₂VCl₂.

The composition according to the invention can comprise from 0.1 to 10, preferably 0.5 to 6, parts by weight of crosslinking/curing catalyst E.

The catalyst can be in the solid or liquid state. It can be incorporated alone or in an appropriate anhydrous solvent, for example a silicone oil.

The single-component silicone mastic composition according to the invention possesses all the advantageous properties specific to this type of product and exhibits in addition rapid crosslinking kinetics and in particular unequalled surface setting kinetics. It can be used to produce elastomeric components having conventional thicknesses in this type of application, namely in particular thicknesses ranging from 0.5 or 1 mm to several centimeters. Typically, in the field of paintings, the thickness can be between 0.5 or 1 mm and 1.5 or 2 cm.

In addition, the mastic composition according to the invention is economical and results in crosslinked elastomers which have advantageous mechanical properties and which adhere to numerous supports.

The composition according to the invention corresponds to an embodiment in which the essential constituent, namely the POS A, is functionalized on its ends (generally initially carrying hydroxyl functions) by functionalization radicals R^{fo} originating from a crosslinking silane C. The OH groups of the precursor of the POS A have reacted with the R^{fo} groups of the crosslinking silane C by condensation.

The POS A is functionalized according to techniques known to a person skilled in the art. This functionalized POS A corresponds to a form which is stable in the absence of moisture of the single-component mastic considered here. In practice, this stable form is that of the composition packaged in hermetically sealed cartridges which will be opened by the operator during use and which will allow him to apply the mastic over all the supports desired.

The hydroxylated precursor A′ of the POS A functionalized by R^{fo} is generally an α,ω-hydroxylated polydiorganosiloxane of formula: 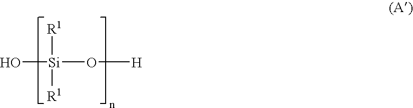
with R¹ and n as defined above in the formula (A).

The optional resin POS B functionalized by R^{fo} resin can be produced in the same way as the POS A functionalized by R^{fo} by condensation with a crosslinking silicone C carrying functionalization radicals R^{fo}.

The precursor of the resin POS B functionalized by R^{fo} can be a hydroxylated resin POS B′ corresponding to the definition given above for B, except that a portion of the radicals R¹ correspond to OH groups.

The single-component mastic composition according to the invention can be of the acid type (acetoxy, and the like) or else of the neutral type (enoxy, oxime, alkoxy, and the like).

According to a preferred arrangement of the invention, the single-component silicone mastic composition concerned is rather of neutral type, for example oxime or alkoxy, which means that the functionalization substituents R^{fo} of the formulae A, B and C, which are identical or different, each represent:
an oxime residue of formula:
   (R³)₂C═N—O—
with R³ independently representing a linear or branched C₁ to C₈ alkyl, a C₃ to C₈ cycloalkyl or a C₂-C₈ alkenyl, preferably selected from the group consisting of methyl, ethyl, propyl, butyl, vinyl and allyl;
and/or an alkoxy residue of formula:
   R⁴O(CH₂CH₂O)_{b}—
with R⁴ independently representing a linear or branched C₁ to C₈ alkyl or a C₁ to C₈ cycloalkyl, preferably selected from the group consisting of methyl, ethyl, propyl, butyl and methyl glycol, and b=0 or 1.

In a more preferred embodiment of the invention, the functionalization substituents R^{fo} are of alkoxy type and correspond to the formula R⁴O(OCH₂CH₂)_{b} as defined above.

Mention will be made, among the auxiliaries H or additives which are particularly advantageous for the composition according to the invention, of adhesion promoters.

Thus, the single-component mastic POS composition according to the invention can comprise at least one adhesion promoter H1 which is non-nucleophilic in particular and nonaminated, preferably chosen from the organosilicon compounds simultaneously carrying:
(1) hydrolyzable groups bonded to the silicon atom and
(2) organic groups substituted by radicals chosen from the group of the (meth)acrylate, epoxy and alkenyl radicals and more preferably still from the group consisting of:
   vinyltrimethoxysilane (VTMO),
   3-glycidoxypropyltrimethoxysilane (GLYMO),
   methacryloyloxypropyltrimethoxysilane (MEMO),
   and their mixtures.

In order to explain in somewhat greater detail the nature of the constituent components of the composition according to the invention, it is important to specify that the substituents R¹ of the polymers POS A functionalized by R^{fo}, of the resins B functionalized by R^{fo} and of the optional nonfunctionalized polymers D can be selected from the group formed by:
alkyl and haloalkyl radicals having from 1 to 13 carbon atoms,
cycloalkyl and halocycloalkyl radicals having from 5 to 13 carbon atoms,
alkenyl radicals having from 2 to 8 carbon atoms,
mononuclear aryl and haloaryl radicals having from 6 to 13 carbon atoms,
cyanoalkyl radicals, the alkyl members of which have from 2 to 3 carbon atoms,
   the methyl, ethyl, propyl, isopropyl, n-hexyl, phenyl, vinyl and 3,3,3-trifluoropropyl radicals being particularly preferred.

More specifically still, and without implied limitation, the substituents R¹ mentioned above for the polymers POS A and D (optional) comprise:
alkyl and haloalkyl radicals having from 1 to 13 carbon atoms, such as the methyl, ethyl, propyl, isopropyl, butyl, pentyl, hexyl, 2-ethylhexyl, octyl, decyl, 3,3,3-trifluoropropyl, 4,4,4-trifluorobutyl or 4,4,4,3,3-pentafluorobutyl radicals,
cycloalkyl and halocycloalkyl radicals having from 5 to 13 carbon atoms, such as the cyclopentyl, cyclohexyl, methylcyclohexyl, propylcyclohexyl, 2,3-difluorocyclobutyl or 3,4-difluoro-5-methylcycloheptyl radicals,
alkenyl radicals having from 2 to 8 carbon atoms, such as the vinyl, allyl or buten-2-yl radicals,
mononuclear aryl and haloaryl radicals having from 6 to 13 carbon atoms, such as the phenyl, tolyl, xylyl, chlorophenyl, dichlorophenyl or trichlorophenyl radicals,
cyanoalkyl radicals, the alkyl members of which have from 2 to 3 carbon atoms, such as the β-cyanoethyl and γ-cyanopropyl radicals.

Mention may be made, as concrete examples of siloxyl units D, (R¹)₂SiO_{2/2}, present in the diorganopolysiloxanes A functionalized by R^{fo} of formula (A) and in the optional unreactive diorganopolysiloxanes D of formula (D), of:
(CH₃)₂SiO,
CH₃(CH₂═CH)SiO,
CH₃(C₆H₅)SiO,
(C₆H₅)₂SiO,
CF₃CH₂CH₂(CH₃)SiO,
NC—CH₂CH₂(CH₃)SiO,
NC—CH(CH₃)CH₂(CH₂═CH)SiO,
NC—CH₂CH₂CH₂(C₆H₅)SiO.

It should be understood that, in the context of the present invention, use may be made, as functionalized polymers A of formula (A), of a mixture composed of several polymers, preferably initially hydroxylated and then functionalized with R^{fo}, which differ from one another in the value of the viscosity and/or the nature of the substituents bonded to the silicon atoms. Furthermore, it should be pointed out that the functionalized polymers A of formula (A) can optionally comprise siloxyl units T of formula R¹SiO_{3/2} and/or siloxyl units Q of formula SiO_{4/2} in the proportion of at most 1% (this % expressing the number of T and/or Q units per 100 silicon atoms). The same comments apply to the nonfunctionalized and unreactive polymers D (optional) of formula (D).

The substituents R¹ of the functionalized polymers A and of the unreactive and nonfunctionalized polymers D (optional) advantageously used, due to their availability in industrial products, are the methyl, ethyl, propyl, isopropyl, n-hexyl, phenyl, vinyl and 3,3,3-trifluoropropyl radicals. More advantageously, at least 80% by number of these substituents are methyl radicals.

Use is made of functionalized polymers A having a dynamic viscosity at 25° C. ranging from 1000 to 1000000 mPa·s and preferably ranging from 10000 to 200000 mPa·s.

As regards the nonfunctionalized polymers D (optional), they exhibit a dynamic viscosity at 25° C. ranging from 10 to 200000 mPa·s and preferably ranging from 50 to 150000 mPa·s.

The unreactive and nonfunctionalized polymers D, when they are used, can be introduced all at once or in several fractions and at several stages or at a single stage of the preparation of the composition.

The possible fractions can be identical or different in terms of nature and/or of proportions. Preferably, D is introduced all at once at a single stage.

Mention may be made, as examples of substituents R¹ of the resins POS B functionalized by R^{fo} which are suitable or which are advantageously used, of the various radicals R¹ of the type of those mentioned by name above for the functionalized polymers A and the unreactive and nonfunctionalized polymers D (optional). These silicone resins are well known branched polyorganosiloxane polymers, the processes for the preparation of which are described in numerous patents. Mention may be made, as concrete examples of resins which can be used, of the MQ, MDQ, TD and MDT resins.

Preferably, mention may be made, as examples of resins which can be used, of the resins POS B functionalized by R^{fo} not comprising, in their structure, the Q unit. More preferably, mention may be made, as examples of resins which can be used, of the functionalized TD and MDT resins comprising at least 20% by weight of T units and having a content by weight of R^{fo} group ranging from 0.3 to 5%. More preferably still, use is made of resins of this type in the structure of which at least 80% by number of the substituents R¹ are methyl radicals. The functional groups R^{fo} of the resins B can be carried by the M, D and/or T units.

As regards the functionalized POSs A and the crosslinking agents C, mention may be made, as concrete examples of substituents R₂ which are particularly suitable, of the same radicals as those mentioned by name above for the substituents R¹ of the functionalized polymers A and of the nonfunctionalized and unreactive polymers D. polymers A and of the nonfunctionalized and unreactive polymers D.

As regards the constituent substituents R³, R⁴ and R⁵ of the functionalization radicals R^{fo}, it will be mentioned that C₁-C₄ alkyl radicals, such as the methyl, ethyl, propyl, isopropyl and n-butyl radicals, prove to be more especially appropriate.

According to the preferred embodiment of the composition according to the invention, the R^{fo} radicals used for the functionalization of the initially hydroxylated POS are of alkoxy type and more preferably still result from silane crosslinking agents C chosen from the group consisting of
Si(OCH₃)₄
Si(OCH₂CH₃)₄
Si(OCH₂CH₂CH₃)₄
(CH₃O)₃SiCH₃
(C₂H₅O)₃SiCH₃
(CH₃O)₃Si(CH═CH₂)
(C₂H₅O)₃Si(CH═CH₂)
(CH₃O)₃Si(CH₂—CH═CH₂)
(CH₃O)₃Si[CH₂—(CH₃)C═CH₂]
(C₂H₅O)₃Si(OCH₃)
Si(OCH₂—CH₂—OCH₃)₄
CH₃Si(OCH₂—CH₂—OCH₃)₃
(CH₂═CH)Si(OCH₂CH₂OCH₃)₃
C₆H₅Si(OCH₃)₃
C₆H₅Si(OCH₂—CH₂—OCH₃)₃.

In practice, the silane crosslinking agents C carrying the functionalization radicals R^{fo} are chosen from: Si(OC₂H₅)₄, CH₃Si(OCH₃)₃, CH₃Si(OC₂H₅)₃, (C₂H₅O)₃Si(OCH₃), (CH₂═CH)Si(OCH₃)₃ or (CH₂═CH)Si(OC₂H₅)₃.

According to one embodiment of the invention, the composition comprising the POS A and the vanadium

The inorganic filler F can be composed of amorphous silica in the form of a solid. The physical state under which the silica is provided is not important, that is to say that said filler can be provided in the form of a powder, of micropearls, of granules or of beads.

All precipitated silicas or pyrogenic silicas (or fumed silicas) known to a person skilled in the art are suitable as amorphous silica capable of being employed in the invention. Of course, use may also be made of blends of various silicas.

Preference is given to precipitated silicas in the powder form, fumed silicas in the powder form or their mixtures; their BET specific surface is generally greater than 40 m²/g and preferably between 100 and 300 m²/g; more preferably, use is made of fumed silicas in the powder form.

According to one alternative form, the filler F can be composed, beyond silicas, of opacifying white fillers, such as calcium carbonates, titanium oxides or aluminum oxides, indeed even of carbon blacks.

In practice, the fillers F can be provided in the form of more coarsely divided inorganic and/or organic products, with a mean particle diameter of greater than 0.1 micron; the preferred fillers include ground quartz, diatomaceous silicas, calcium carbonate, calcined clay, titanium oxide of the rutile type, iron, zinc, chromium, zirconium or magnesium oxides, the various forms of alumina (hydrated or nonhydrated), boron nitride, lithopone, barium metaborate, cork powder, wood sawdust, phthalocyanines, inorganic and organic fibers, and organic polymers (polytetrafluoroethylene, polyethylene, polypropylene, polystyrene or poly(vinyl chloride)). (polytetrafluoroethylene, polyethylene, polypropylene, polystyrene or poly(vinyl chloride)).

These fillers can be modified at the surface, and more especially fillers of inorganic origin, by treatment with the various organosilicon compounds commonly employed for this use. Thus, these organosilicon compounds can be organochlorosilanes, diorganocyclopolysiloxanes, hexaorganodisiloxanes, hexaorganodisilazanes or diorganocyclopolysilazanes (patents FR 1 126 884, FR 1 136 885, FR 1 236 505 and GB 1 024 234). The treated fillers include, in the majority of cases, from 3 to 30% of their weight of organosilicon compounds.

The purpose of the introduction of the fillers is to confer good mechanical and Theological characteristics on the elastomers resulting from the curing of the compositions in accordance with the invention. A single type of filler or mixtures of several types can be introduced.

Use may be made, in combination with these fillers, of inorganic and/or organic pigments and of agents which improve the temperature stability (rare earth metal salts and oxides, such as ceric oxides and hydroxides) and/or the flame resistance of the elastomers. Mention may be made, among the agents for improving the flame resistance, of halogenated organic derivatives, organic phosphorus derivatives, platinum derivatives, such as chloroplatinic acid (its reaction products with alkanols or ethers), or platinous chloride-olefin complexes. These pigments and agents together represent at most 20% of the weight of the fillers.

According to a preferred characteristic of the invention, the single-component mastic POS composition comprises:
100 parts by weight of linear diorganopolysiloxane(s) A functionalized by R^{fo},
from 0 to 30, preferably from 5 to 15, parts by weight of hydroxylated resin(s) B,
from 2 to 15, preferably from 3.5 to 12, parts by weight of crosslinking agent(s) C,
from 0 to 60, preferably from 5 to 60, parts by weight of nonfunctionalized and unreactive linear diorganopolysiloxane(s) D,
from 0.1 to 10, preferably from 0.5 to 6, parts by weight of crosslinking/curing catalyst E,
from 2 to 250, preferably from 10 to 200, parts by weight of filler based on silica and/or on carbonate F, and
from 0 to 20, in particular from 0.1 to 20, preferably from 0.1 to 10, parts by weight of adhesion promoter H.

Other conventional auxiliary agents and additives H can be incorporated in the composition according to the invention; these are chosen according to the applications in which said compositions are used.

The compositions in accordance with the invention cure at ambient temperature and in particular at temperatures of between 5 and 35° C. in the presence of moisture. The curing (or the crosslinking) takes place from the exterior towards the interior of the body of the compositions. A skin is first formed at the surface and then the crosslinking continues in the body of the compositions.

These compositions can be employed for multiple applications, such as pointing in the construction industry, the assembling and adhesive bonding of the most diverse materials (metals; plastics, such as, for example, PVC or PMMA; natural and synthetic rubbers; wood; board; earthenware; brick; glass; stone; concrete; masonry components), both in the context of the construction industry and in that of the automobile, domestic electrical appliance and electronics industries.

According to another of its aspects, another subject matter of the present invention is an elastomer, in particular an elastomer capable of adhering to various substrates, obtained by crosslinking and curing the single-component silicone mastic composition described above.

The single-component organopolysiloxane compositions in accordance with the present invention are prepared with the exclusion of moisture by carrying out the preparation in a closed reactor equipped with a stirrer in which it is possible, if required, to apply vacuum and then optionally to replace the air expelled with an anhydrous gas, for example with nitrogen.

Mention may be made, as examples of equipment, of: slow dispersers, paddle, propeller, arm or anchor mixers, planetary mixers, hook mixers, or single-screw or multiple-screw extruders;

A further subject matter of the invention is the use of a vanadium compound as catalyst for a single-component polyorganosiloxane (POS) composition which is stable on storage in the absence of moisture and which crosslinks in the presence of water to give an elastomer, which composition comprises at least one crosslinkable linear polyorganopolysiloxane POS and an inorganic filler, the POS exhibiting nonhydroxylated functionalized ends, in particular ends of alkoxy, oxime, acyl and/or enoxy type, preferably alkoxy type, the composition being essentially, preferably completely, devoid of POS possessing hydroxylated ends. In the context of this use, the vanadium compound, the POS, the filler and the other optional constituents, in their various forms, are as described above.

The invention will be better understood with the help of the following nonlimiting examples.

### EXAMPLES

### Comparative Example 1

### Formulation of an RTV1 Catalyzed by Ti(OBu)₄

791 g of α,ω-dihydroxylated polydimethylsiloxane oil (hydroxylated oil) with a viscosity of approximately 130 000 mPa·s, 240 g of α,ω-trimethylsilylated polydimethylsiloxane oil (methylated oil) with a viscosity of approximately 100 mPa·s, 3.6 g of a polyether of Breox B225® type and 36.0 g of crosslinking agent of vinyltrimethoxysilane type are charged to the vessel of a “butterfly” uniaxial mixer. The combined product is mixed at 200 rev/min for 2 min and 4.6 g of a lithium hydroxide functionalization catalyst are introduced into the vessel. The functionalization reaction is allowed to take place for 4 min with stirring at 400 rev/min and then 114 g of pyrogenic silica with a specific surface of approximately 150 m²/g are incorporated at a moderate stirring rate (160 rev/min) and then at a higher stirring rate (4 min at 400 rev/min) to complete the dispersing of the silica in the mixture.

15.6 g (i.e., 3.8 mmol/100 g) of catalyst (titanium tetrabutoxide [CH₃(CH₂)₃O]₄Ti) are then introduced over 30 s. Mixing is carried out at 400 rev/min for 4 min and then at 130 rev/min for 6 min under a vacuum of 29 mbar. A paste is obtained and is transferred into a hermetically sealed cartridge.

### Example 2

### Formulation of an RTV1 Catalyzed by [(CH₃)₂CH—O]₃VO

The process is identical to the preceding process but, instead of introducing the titanium catalyst, 11.2 g (i.e., 3.8 mmol/100 g) of vanadyl triisopropoxide ([(CH₃)₂CH—O]₃VO) catalyst are introduced.

Results of Examples 1 and 2:

| Catalyst | |
|---|---|
| Ti(OBu)₄ | [(CH₃)₂CH—O]₃VO |

| Conditions | Initial | Aged* | Initial | Aged* |
|---|---|---|---|---|
| Flowability (mm in | 1 | Nd | 0 | Nd |
| 30 min) | | | | |
| Extrusion (3 mm nozzle | 60.4 | Nd | 47.5 | Nd |
| under 3 bar) | | | | |
| Skin formation time | 11 | Nd | 1 | Nd |
| (min) | | | | |
| Tack-free time (min) | >120 | Nd | 30 | Nd |

Properties after crosslinking for 7 days:

| | | | | |
|---|---|---|---|---|
| Tensile strength (MPa) | 1.95 | Nd | 2.1 | Nd |
| Elongation at break (%) | 650 | Nd | 590 | Nd |
| 100% Modulus (MPa) | 0.36 | Nd | 0.43 | Nd |
| Hardness, 6 mm (Shore A) | 17.5 | 11 | 21 | 15 |

*Cartridge aged 21 days at 50° C. (accelerated aging)
Nd: not determined

Comments: With the vanadium catalyst, a stable product is obtained which has properties equivalent to those of the control using a conventional catalyst. A higher level of crosslinking is observed. The major advantage is that it provides extremely fast setting kinetics and in particular surface setting kinetics (characterized both by the SFT defined above and the tack-free time) in comparison with the control using a titanium catalyst.

After an aging test, the setting of the mastic catalyzed with [(CH₃)₂CH—O]₃VO continues to crosslink and to form a network entirely compatible with the application, whereas the mastic with Ti(OBu)₄ shrinks.

### Example 3

### Synthesis of a Catalyst-free Base (Paste)

1030 g of α,ω-dihydroxylated polydimethylsiloxane oil (“hydroxylated” oil) with a viscosity of approximately 50 000 mPa·s and 33.0 g of crosslinking agent of vinyltrimethoxysilane type are charged to the vessel of a “butterfly” uniaxial mixer. The combined product is mixed at 200 rev/min for 2 min and 4.2 g of a lithium hydroxide functionalization catalyst are introduced into the vessel. The functionalization reaction is allowed to take place for 4 min with stirring at 400 rev/min and then 33.0 g of pyrogenic silica with a specific surface of approximately 150 m²/g are incorporated at a moderate stirring rate (160 rev/min) and then at a higher stirring rate (4 min at 400 rev/min) to complete the dispersing of the silica in the mixture. A rather thick but still flowing viscoelastic fluid is obtained. The paste obtained is degassed under vacuum (6 min at 130 rev/min under a vacuum of 30 mbar) and then transferred into a container for storage.

### Example 4

### Addition of Catalysts to the Paste

In order to obtain an elastomer which crosslinks with atmospheric moisture, an amount X of various condensation catalysts corresponding to a fixed amount in moles of catalytic entity was added to 30-X g of the paste obtained in example 3.

The various catalysts compared are:
Fascat® 4202 CL from Atofina (dibutyltin dilaurate), comprising 18.1% of tin;
tetrabutyl titanate (“TBT”), comprising 14.1% of titanium;
vanadyl triisopropoxide, [(CH₃)₂CH—O]₃VO, comprising 20.9% of vanadium;
vanadyl trichloride, Cl₃VO, comprising 29.4% of vanadium;
vanadyl naphthenate (“NaVO”) at 35% in naphthenic acid, comprising approximately 3% of vanadium.
   Results:

The catalytic potentialities of each composition were evaluated in three ways:
the skin formation time “SFT” (time at the end of which surface crosslinking is observed);
the persistence of a tacky feel at 24 h (“TF 24 h”);

the hardness (by Shore A) after crosslinking at 23° C./50% RH for 7 days (hardness of the top/bottom faces of a disk-shaped specimen with a thickness of approximately 6 mm), standard ASTM-D-2240.

| | | | | | | Hardness | |
|---|---|---|---|---|---|---|---|
| | | | | | TF 24 h | (Shore A) | |
| Catalyst | X (%) | [cata] (μmol/g) | SFT | | (yes/no) | top | bottom |
| Fascat | 2.5 | 38 | 10 | min | No | 18.5 | 17 |
| 4202 CL | | | | | | | |
| TBT | 1.3 | 38 | 30 | min | No | 19 | 13.5 |
| [(CH₃)₂CH—O]₃VO | 0.93 | 38 | 5 | min | No | 23 | 13.5 |
| Cl₃VO | 0.66 | 38 | 5 | min | No | 21 | 12 |
| “NaVO” | 6.5 | 38 | >1 | h | No | 19 | 19 |

Comments

The vanadyl catalysts make possible good crosslinking. The setting rate is much better than that of the titanium catalyst and of the tin catalyst. They make it possible to achieve a tack-free feel before 24 h. The hardness at 7 days can vary according to the catalysts and can range up to 20-23 Shore A at the surface in contact with the air. The bottom face (in contact with the support) also exhibits a satisfactory level of crosslinking after 7 days with a hardness still of greater than 12 Shore A, which demonstrates the existence of core crosslinking.

It should be clearly understood that the invention defined by the appended claims is not limited to the specific embodiments indicated in the description above but encompasses the alternative forms thereof which depart neither from the scope nor from the spirit of the present invention.

1-17. (canceled)

18. A single-component polyorganosiloxane (POS) composition which is stable on storage in the absence of moisture and which crosslinks in the presence of water into an elastomer, which composition comprises at least one crosslinkable linear polyorganopolysiloxane POS, an inorganic filler and a crosslinking catalyst, wherein the POS contains non-hydroxylated functionalized endgroups, and said composition being essentially devoid of hydroxylated POSs and said catalyst comprising a vanadium compound.

19. The POS composition as defined by claim 18, comprising:
(A) at least one crosslinkable linear polyorganopolysiloxane A of formula: 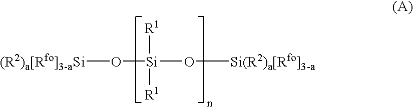
in which:
the substituents R¹, which may be identical or different, are each a saturated or unsaturated, substituted or unsubstituted, aliphatic, cyclanic or aromatic, C₁ to C₁₃ monovalent hydrocarbon radical;
the substituents R², which may be identical or different, are each a saturated or unsaturated, substituted or unsubstituted, aliphatic, cyclanic or aromatic, C₁ to C₁₃ monovalent hydrocarbon radical;
the functionalization substituents R^{fo}, which may be identical or different, each represent:
an oxime residue of formula:
(R³)₂C═N—O—
with R³ independently representing a linear or branched C₁ to C₈ alkyl radical, a C₃ to C₈ cycloalkyl radical or a C₂-C₈ alkenyl radical;
an alkoxy residue of formula:
R⁴O(CH₂CH₂O)_{b}—
with R⁴ independently representing a linear or branched C₁ to C₈ alkyl radical or a C₃ to C₈ cycloalkyl radical and b=0 or 1;
an acyl residue of formula: 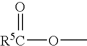
with R⁵ representing a saturated or unsaturated, branched or unbranched, substituted or unsubstituted, aliphatic, cyclanic or aromatic, C₁ to C₁₃ monovalent hydrocarbon radical;
an enoxy residue of formula:
R⁶R⁶C═CR⁶—O—
with the R⁶ groups, which may be identical or different, each representing hydrogen or a saturated or unsaturated, branched or unbranched, substituted or unsubstituted, aliphatic, cyclanic or aromatic, C₁ to C₁₃ monovalent hydrocarbon radical;
n has a value sufficient to confer, on the POS A, a dynamic viscosity at 25° C. ranging from 1,000 to 1,000,000 mPa·s;
a is zero or 1;
(B) optionally, at least one polyorganosiloxane resin B functionalized by at least one radical R^{fo} as defined above and having in its structure, at least two different siloxyl units selected from among those of formulae (R¹)₃SiO_{1/2} (M unit), (R¹)₂SiO_{2/2} (D unit), R¹SiO_{3/2} (T unit) and SiO₂ (Q unit), at least one of these units being a T or Q unit, the radicals R¹, which may be identical or different, are as defined above with respect to the formula (A) and said resin having a content by weight of functional radicals R^{fo} ranging from 0.1 to 10%, with the proviso that a portion of the radicals R¹ are radicals R^{fo};
(C) optionally, at least one crosslinking agent C of formula:
(R²)ₐSi[R^{fo}]₄₋ₐ
with R², R^{fo} and a being as defined above;
(D) optionally, at least one linear polydiorganosiloxane D which is unreactive and which is not functionalized with R^{fo}, of formula: 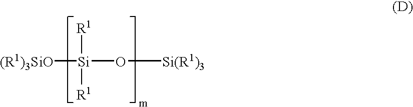
in which:
the substituents R¹, which may be identical or different, are as defined above for the polyorganosiloxane A of formula (A);
m has a value sufficient to confer, on the polymer of formula (D), a dynamic viscosity at 25° C. ranging from 10 to 200,000 mPa·s;
(E) an effective amount of a vanadium compound E as crosslinking catalyst or accelerator;
(F) an inorganic filler F;
(H) optionally, at least one auxiliary agent H.

20. The POS composition as defined by claim 19, wherein the compound E is a compound of vanadium in the 5 oxidation state of formula (E₁): X₃VO, in which the radicals X, which may be identical or different, are selected from the group consisting of 1-electron radical ligands X, alkoxy radicals, halogen atoms, 3-electron radical ligands LX, and ligands derived from acetylacetone, from a β-keto ester, from a malonic ester, from an allyl compound, from a carbamate, from a dithiocarbamate or from a carboxylic acid.

21. The POS composition as defined by claim 20, wherein the vanadium compound is [(CH₃)₂CHO]₃VO, (CH₃CH₂O)₃VO, [(CH₃)₃CO]₃VO, [(CH₃CH₂)(CH₃)CHO]₃VO or [(CH₃)₂(CH₂)CHO]₃VO.

22. The POS composition as defined by claim 19, wherein the compound E is a compound of vanadium in the 4 oxidation state of formula (E₂): X₂VO, in which the radicals X, which may be identical or different, are selected from the group consisting of 1-electron radical ligands X, alkoxy radicals, halogen atoms, 3-electron radical ligands LX, and ligands derived from acetylacetone, from a β-keto ester, from a malonic ester, from an allyl compound, from a carbamate, from a dithiocarbamate or from a carboxylic acid.

23. The POS composition as defined by claim 22, wherein the vanadium compound is VOCl₂, [(CH₃)₂CHO]₂VO, (CH₃CH₂O)₂VO,[(CH₃)₃CO]₂VO, [(CH₃CH₂)(CH₃)CHO]₂VO or [(CH₃)₂(CH₂)CHO]₂VO.

24. The POS composition as defined by claims 20 or 22, wherein the formula (E₁) or (E₂) comprises an OR group in which R is a linear or branched C₁-C₁₃ alkyl radical or a C₃-C₈ cycloalkyl radical.

25. The POS composition as defined by claim 19, wherein the compound E is a compound of vanadium in the 4 oxidation state of formula (E₃): VX₄, in which the X groups, which may be identical or different, are each a halogen atom, or an alkoxy radical OR with R representing a linear or branched C₁-C₁₃ alkyl radical or a C₃-C₈ cycloalkyl radical.

26. The POS composition as defined by claim 25, wherein the vanadium compound is [(CH₃)₂CHO]₄V, (CH₃O)₄V, (CH₃CH₂O)₄V, [(CH₃)₃CO]₄V, [(CH₃CH₂)(CH₃)CHO]₄V or [(CH₃)₂(CH₂)CHO]₄V.

27. The POS composition as defined by claim 19, wherein the compound E is a compound of vanadium in the 3 oxidation state of formula (E₄): XVO, in which the radical X is a 3-electron radical ligand LX, including a ligand derived from acetylacetone, from a β-keto ester, from a malonic ester, from an allyl compound, from a carbamate, from a dithiocarbamate or from a carboxylic acid.

28. The POS composition as defined by claim 20, wherein the formula (E₁), the 3-electron radical ligands LX are selected from among the acetylacetonato (CH₃COCHCOCH₃) and allyl (CH₂═CH—CH₂) radicals.

29. The POS composition as defined by claim 19, wherein the compound E is a compound of vanadium in the 5 oxidation state comprising 5-electron radical ligands L₂X, dienyl ligands, or cyclopentadienyl ligands.

30. The POS composition as defined by claim 19, comprising from 0.1 to 10 parts by weight of crosslinking/curing catalyst E.

31. The POS composition as defined by claim 19, wherein the functionalization substituents R^{fo} are alkoxy radicals of formula R⁴O(CH₂CH₂O)_{b}—, in which R⁴ is a linear or branched C₁ to C₈ alkyl radical or a C₃ to C₈ cycloalkyl radical and b=0 or 1.

32. The POS composition as defined by claim 19, wherein the substituents R¹ of the polymers POS A functionalized by R^{fo}, of the resins B functionalized by R^{fo} and of the optional non-functionalized and unreactive polymers D are selected from the group consisting of:
alkyl and haloalkyl radicals having from 1 to 13 carbon atoms,
cycloalkyl and halocycloalkyl radicals having from 5 to 13 carbon atoms,
alkenyl radicals having from 2 to 8 carbon atoms,
mononuclear aryl and haloaryl radicals having from 6 to 13 carbon atoms, and
cyanoalkyl radicals, the alkyl members of which have from 2 to 3 carbon atoms.

33. An elastomer capable of adhering to various substrates and obtained by crosslinking and curing the POS composition as defined by claim 18.
